(19) United States
(12) Patent Application Publication
(10) Pub. No.: US 2010/0194561 A1
(43) Pub. Date: Aug. 5, 2010

(54) ELECTRONIC CIRCUIT, ELECTRONIC DEVICE, AND GAIN CONTROL METHOD

(75) Inventors: Tadahiro Motoyama, Yokohama-shi (JP); Hiroyuki Oku, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/671,193

(22) PCT Filed: Jul. 31, 2007
(86) PCT No.: PCT/JP2007/064959

§ 371 Date: Jan. 28, 2010

(51) Int. Cl. G08B 21/00

(52) U.S. Cl. 340/540

(57) ABSTRACT

By automatically adjusting a gain according to the presence or absence of head set connection and a head set microphone, an electronic circuit has improved sound collecting performance and prevents the microphone from casually collecting sound. In the circuit, a voltage detecting unit (105) outputs a result of comparison between power voltage and a threshold value or a digital value of the power voltage. A control unit (106) detects the presence or absence of a head set microphone (161) based on the comparison result or the digital value of the power voltage in the voltage detecting unit (105). A gain setting unit (109) sets a gain of a value larger than that in the case where the absence of the head set connection is detected by the control unit (106), when the presence of the head set connection and the absence of the head set microphone are detected by the control unit (106). A variable amplifier (110) amplifies audio data from a body microphone (107) using the gain set by the gain setting unit (109).

### TECHNICAL FIELD

The present invention relates to an electronic circuit, electronic device and gain control method. More particularly, the present invention relates to an electronic circuit, electronic device and gain control method for automatically detecting the presence/absence of the headset microphone of a headset and adjusting the gain.

### BACKGROUND ART

Conventionally, a microphone switching apparatus that automatically switches between the microphone of a headset and the main unit microphone incorporated in an electronic device is known (e.g. Patent Document 1).

According to Patent Document 1, a microphone switching apparatus electrically detects whether a plug inserted into a jack, which is shared by the headset and earphones, belongs to the headset or the earphones. The microphone switching apparatus switches connections between a microphone line of a radio set main unit, a microphone line of the jack and a microphone line to a built-in microphone according to the detected signal. Furthermore, when the plug is not inserted in the jack, the microphone switching apparatus has a function of connecting the microphone line of the radio set main unit to the microphone line of the jack.

Furthermore, there are two types of headsets; one provided with a headset microphone and the other without a headset microphone.

Patent Document 1: Japanese Patent Publication No. 3169732

### DISCLOSURE OF INVENTION

### Problems to be Solved by the Invention

However, conventional apparatuses have a problem that, when the headset is not provided with a headset microphone, voice collected by the main unit microphone of the device located apart from the mouth becomes indistinct. According to Patent Document 1, when, for example, the user cannot visually check the display screen of the device while driving a vehicle or the like, the user is likely to be unable to recognize a report on the presence/absence of a headset microphone displayed on the display screen. In this case, although the headset provided without a headset microphone is connected to the device, if the user mistakes it for being provided with the headset microphone, the user is likely to communicate in such an undertone that could be collected only by a headset microphone. As a result, there is a problem that the voice collected by the main unit microphone becomes indistinct. To solve this problem, the sound collecting performance of the microphone may be improved. However, in this case, although the headset provided with a headset microphone is connected to the device, if the user mistakes it for being not provided with the headset microphone, there is a problem that when the user is engaged in a conversation in an undertone whose contents should not be heard, the voice may be collected by the headset microphone.

It is therefore an object of the present invention to provide an electronic circuit, electronic device and gain control method that automatically adjusts the gain according to the presence/absence of a headset microphone, and can thereby improve sound collecting performance and prevent sound from being carelessly collected by the microphone.

### Means for Solving the Problem

The electronic circuit of the present invention adopts a configuration including a detecting section that detects the presence/absence of a connection of a headset and the presence/absence of a headset microphone of the connected headset, a gain setting section that sets a first gain when the detecting section detects the absence of the connection of the headset and sets a second gain greater than the first gain when the detecting section detects the presence of the connection of the headset and detects the absence of the headset microphone, and an amplification section that amplifies a signal inputted from the main unit microphone at the first gain or the second gain.

The gain control method of the present invention includes a step of detecting the presence/absence of a connection of a headset and the presence/absence of a headset microphone of the connected headset and a step of setting a first gain when the absence of the connection of the headset is detected and setting a second gain greater than the first gain when the presence of the connection of the headset and the absence of the headset microphone are detected.

### ADVANTAGEOUS EFFECTS OF INVENTION

The present invention automatically adjusts the gain according to the presence/absence of a headset microphone, and can thereby improve the sound collecting performance and prevent sound from being carelessly collected by the microphone.

### BRIEF DESCRIPTION OF DRAWINGS

FIG. 1 is a block diagram illustrating a configuration of an electronic device according to an embodiment of the present invention;

FIG. 2 illustrates a configuration of a voltage detecting section according to the embodiment of the present invention;

FIG. 3 illustrates a configuration of the voltage detecting section according to the embodiment of the present invention;

FIG. 4 illustrates a configuration of the voltage detecting section according to the embodiment of the present invention;

FIG. 5 is a flowchart illustrating operations of the electronic device according to the embodiment of the present invention;

FIG. 6 is a flowchart illustrating operations of the electronic device according to the embodiment of the present invention;

FIG. 7 is a flowchart illustrating operations of the electronic device according to the embodiment of the present invention;

FIG. 8 is a flowchart illustrating operations of the electronic device according to the embodiment of the present invention;

FIG. 9 is a flowchart illustrating operations of the electronic device according to the embodiment of the present invention;

FIG. 10 is a flowchart illustrating operations of the electronic device according to the embodiment of the present invention;

FIG. 11 is a flowchart illustrating a method of informing via voice that the headset microphone or the main unit microphone according to the embodiment of the present invention has been selected; and

FIG. 12 illustrates the gain to be set by the gain setting section according to the embodiment of the present invention.

### BEST MODE FOR CARRYING OUT THE INVENTION

Hereinafter, an embodiment of the present invention will be explained in detail with reference to the accompanying drawings.

### Embodiment

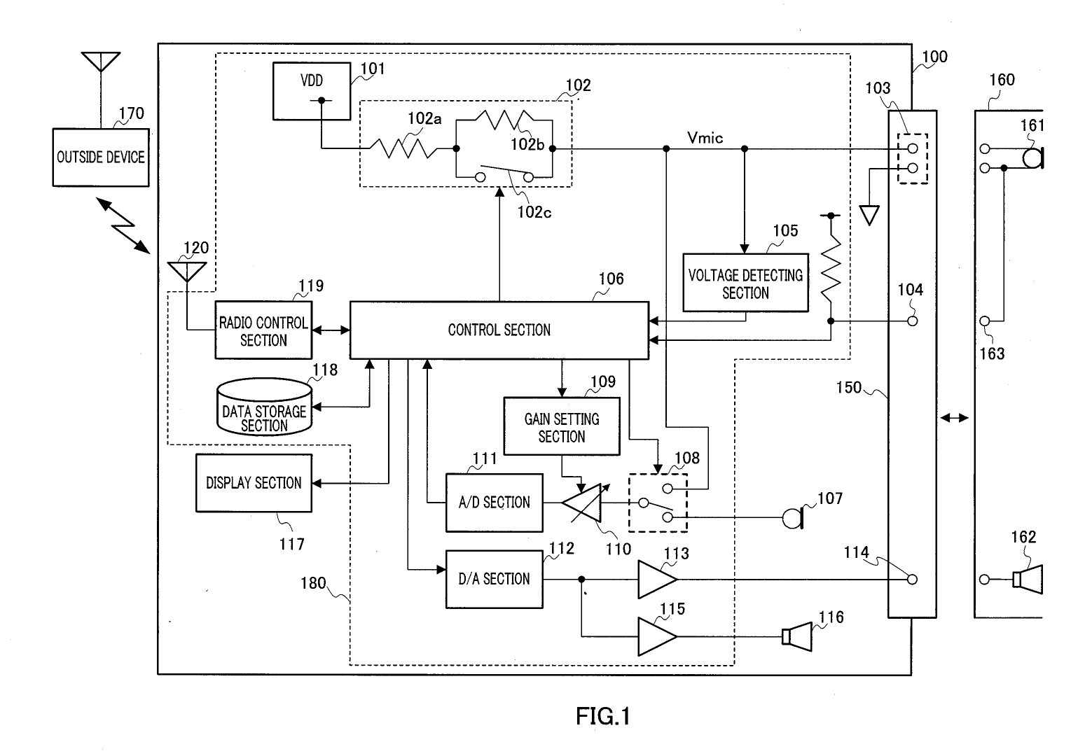

FIG. 1 is a block diagram illustrating a configuration of electronic device 100 according to an embodiment of the present invention. In FIG. 1, headset connection section 150 includes headset microphone connection section 103, headset connection section 104 and headset speaker connection section 114.

When headset 160 is connected to headset connection section 150, power supply section 101 supplies power to headset 160 and headset microphone 161 via impedance setting section 102.

Impedance setting section 102 has resistor 102a, resistor 102b and switch 102c. Furthermore, impedance setting section 102 has a circuit configuration in which resistor 102b and switch 102c are arranged parallel. Furthermore, impedance setting section 102 can variably set an impedance by opening/closing switch 102c according to the control of control section 106. To be more specific, impedance setting section 102 opens switch 102c at the timing of detecting headset microphone 161 and closes switch 102c at timing of not detecting headset microphone 161. Furthermore, resistor 102a is set to, for example, 2 k ohm and resistor 102b is set to, for example, 100 k ohm.

Headset microphone connection section 103 is left open when headset microphone 161 is not connected thereto. Furthermore, headset microphone connection section 103 is electrically and mechanically connected to headset microphone 161. Furthermore, when headset microphone 161 is connected thereto, headset microphone connection section 103 supplies power supplied from power supply section 101 via impedance setting section 102 to headset microphone 161.

Headset connection section 104 is electrically and mechanically connected to connection section 163 of headset 160.

Voltage detecting section 105 outputs a result of a comparison between a supply voltage supplied from power supply section 101 via impedance setting section 102 and a threshold or a digital value of a supply voltage supplied from power supply section 101 via impedance setting section 102 to control section 106. Details of the configuration of voltage detecting section 105 will be described later.

Control section 106 controls impedance setting section 102 so as to open switch 102c at the timing of detecting headset microphone 161. For example, control section 106 starts detection processing on headset microphone 161 in a predetermined cycle or upon detecting a communication start operation by an operation section (not shown). Furthermore, when the amount of voltage drop by the connection between headset connection section 104 and connection section 163 reaches or exceeds a predetermined amount, control section 106 detects the presence of the connection of the headset. Furthermore, control section 106 detects the presence/absence of headset microphone 161 based on the comparison result inputted from voltage detecting section 105 or the digital value of the supply voltage. Control section 106 then outputs the detection result on the presence/absence of headset microphone 161 to gain setting section 109 and causes data storage section 118 to store the information about the presence/absence of headset microphone 161. Furthermore, control section 106 causes display section 117 to display the presence/absence of headset microphone 161 and outputs digital voice data for causing main unit speaker 116 to output the presence/absence of headset microphone 161 via voice to D/A section 112.

Furthermore, upon detecting the presence of the headset microphone, control section 106 reads the digital voice data stored in data storage section 118 and outputs the read digital voice data to D/A section 112. Furthermore, control section 106 modulates the digital voice data inputted from A/D section 111, generates a transmission signal and outputs the transmission signal generated to radio control section 121. Furthermore, control section 106 demodulates the received signal inputted from radio control section 121, acquires digital voice data and outputs the digital voice data acquired to D/A section 112. Furthermore, control section 106 uses the digital voice data inputted from A/D section 111 for a voice recognition application operated by control section 106. Furthermore, control section 106 controls microphone selection section 108 so as to select main unit microphone 107 when no connection of headset 160 is detected or when the absence of the headset microphone is detected, or select headset microphone 161 when the presence of the headset microphone is detected.

Main unit microphone 107 collects outside sound such as voice. Main unit microphone 107 outputs the voice data of the sound collected to variable amplifier 110 via microphone selection section 108.

Microphone selection section 108 switches between outputting the voice data inputted from main unit microphone 107 to variable amplifier 110 and outputting the voice data inputted from headset microphone 161 to variable amplifier 110 according to the control of control section 106.

Gain setting section 109 controls the gain of variable amplifier 110 according to the detection result of the presence/absence of headset microphone 161 inputted from control section 106. To be more specific, gain setting section 109 controls the gain of variable amplifier 110 so as to set a gain of a greater value when control section 106 detects the presence of the connection of the headset and also detects the absence of the headset microphone compared to when control section 106 detects the absence of the connection of the headset.

Variable amplifier 110 amplifies the voice data inputted from main unit microphone 107 via microphone selection section 108 at a predetermined gain according to the control of gain setting section 109 and outputs the amplified voice data to A/D section 111. Furthermore, variable amplifier 110 amplifies the voice data inputted from headset microphone 161 via microphone selection section 108 at a gain matching the characteristics of headset microphone 161 according to the control of gain setting section 109 and outputs the amplified voice data to A/D section 111.

A/D section 111 converts the voice data inputted from variable amplifier 110 from analog voice data to digital voice data and outputs the digital voice data to control section 106.

D/A section 112 converts the digital voice data inputted from control section 106 to analog voice data and outputs the analog voice data to amplifier 113 or amplifier 115.

Amplifier 113 amplifies the analog voice data inputted from D/A section 112 and outputs the amplified analog voice data to headset speaker connection section 114.

Headset speaker connection section 114 outputs analog voice data inputted from amplifier 113 to headset speaker 162.

Amplifier 115 amplifies the analog voice data inputted from D/A section 112 and outputs the amplified analog voice data to main unit speaker 116.

Main unit speaker 116 outputs the sound of the analog voice data inputted from amplifier 115 to the outside.

Display section 117 displays the information that headset microphone 161 has been selected or that main unit microphone 107 has been selected according to an instruction of control section 106.

Data storage section 118 stores information about the presence/absence of headset microphone 161 inputted from control section 106. Furthermore, data storage section 118 stores the digital voice data inputted from control section 106.

Radio control section 119 up-converts the transmission signal inputted from control section 106 from a baseband frequency to a radio frequency and outputs the transmission signal to antenna 120. Furthermore, radio control section 119 down-converts the received signal inputted from antenna 120 from a radio frequency to a baseband frequency and outputs the received signal to control section 106.

Antenna 120 sends the transmission signal inputted from radio control section 119 to outside device 170. Furthermore, antenna 120 receives a signal transmitted from outside device 170 and outputs the signal to radio control section 119. In FIG. 1, communication with outside device 170 is carried out using a radio channel, but the present invention is not limited to this and communication may be carried out using a cable. Furthermore, any device such as a communication terminal apparatus such as a mobile phone or personal computer can be used as outside device 170.

In FIG. 1, a case has been described where the present invention is applied to an electronic device, but the present invention is not limited to this and can be applied to an electronic circuit such as an LSI. That is, the present invention can be configured as electronic circuit 180 formed with power supply circuit 101, impedance setting circuit 102, voltage detection circuit 105, control circuit 106, microphone selection circuit 108, gain setting circuit 109, variable amplification circuit 110, A/D circuit 111, D/A circuit 112, amplification circuit 113, amplification circuit 115, data storage circuit 118 and radio control circuit 119. Furthermore, the above described respective circuits can be mounted on a single substrate as one LSI. Furthermore, only some of the above described respective circuits can be implemented as an LSI. Furthermore, the above described respective circuits may also be mounted on a plurality of substrates. Furthermore, the above described electronic circuit may also be incorporated in an electronic device.

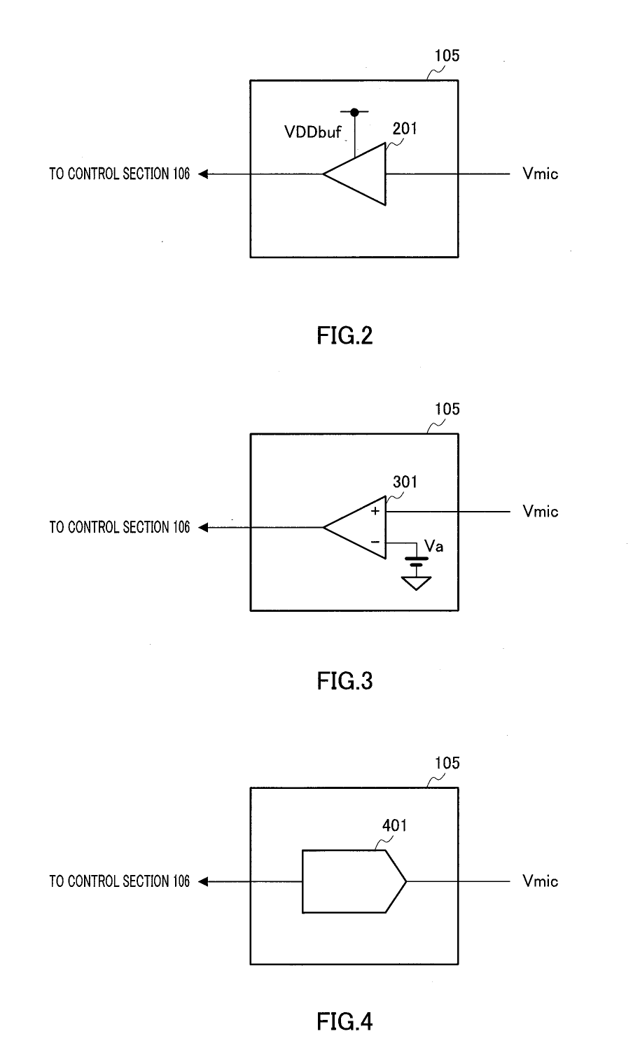

Next, a detailed configuration of voltage detecting section 105 will be explained using FIG. 2. FIG. 2 illustrates a configuration of voltage detecting section 105.

Voltage detecting section 105 outputs a result of a comparison between an input voltage Vmic and a threshold va (here, va≈1/2 VDDbuf) in buffer 201 to control section 106. To be more specific, when Vmic>va, voltage detecting section 105 outputs a high level signal to control section 106. On the other hand, when Vmic<va, voltage detecting section 105 outputs a low level signal to control section 106. Thus, when a high level signal is inputted, control section 106 detects the absence of the headset microphone and when a low level signal is inputted, control section 106 detects the presence of the headset microphone.

FIG. 3 illustrates another configuration example of voltage detecting section 105.

In FIG. 3, voltage detecting section 105 outputs a result of a comparison between an input voltage Vmic and an arbitrary threshold va in voltage detection comparator 301 to control section 106. To be more specific, when Vmic>va, voltage detecting section 105 outputs a high level signal to control section 106. On the other hand, when Vmic<va, voltage detecting section 105 outputs a low level signal to control section 106. Thus, when a high level signal is inputted, control section 106 detects the absence of the headset microphone and when a low level signal is inputted, control section 106 detects the presence of the headset microphone.

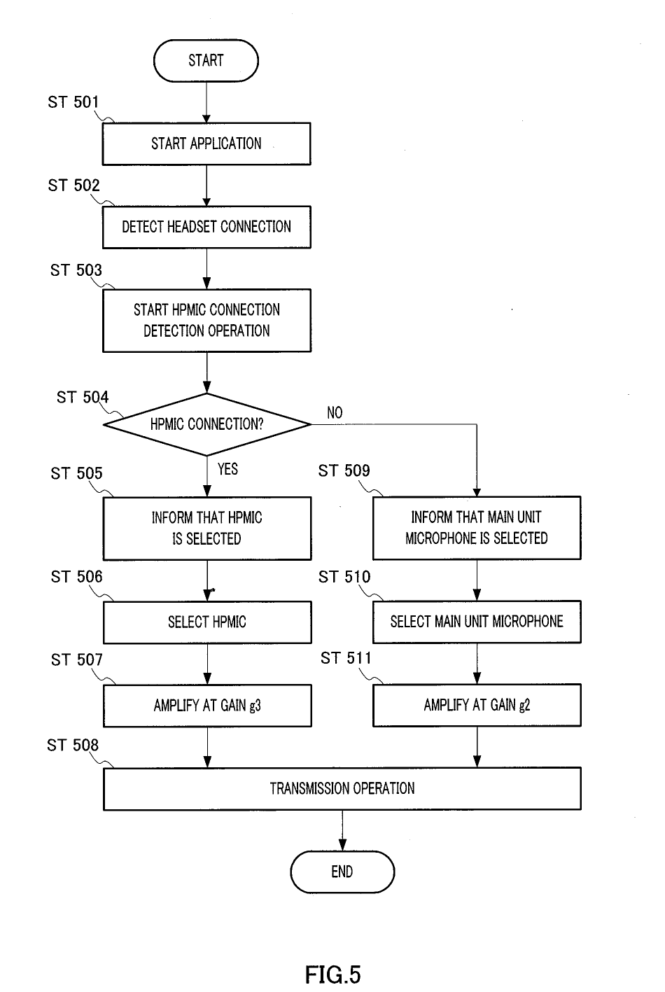

FIG. 4 illustrates a further configuration example of voltage detecting section 105.

In FIG. 4, voltage detecting section 105 outputs a multi-value signal as an analog/digital conversion result of an input voltage Vmic in A/D converter 401 to control section 106. In this way, control section 106 detects the presence/absence of headset microphone 161 according to a result of a comparison between the Vmic which is a digital value inputted from voltage detecting section 105 and a threshold va which is a preset digital value. To be more specific, when Vmic>va, control section 106 detects the absence of the headset microphone and when Vmic<va, control section 106 detects the presence of the headset microphone.

The configuration of voltage detecting section 105 is not limited to the cases in FIG. 2 to FIG. 4 and any configuration other than those in FIG. 2 to FIG. 4 can be adopted.

Next, operations of electronic device 100 will be explained using FIG. 5 to FIG. 10. FIG. 5 to FIG. 10 are flowcharts illustrating operations of electronic device 100.

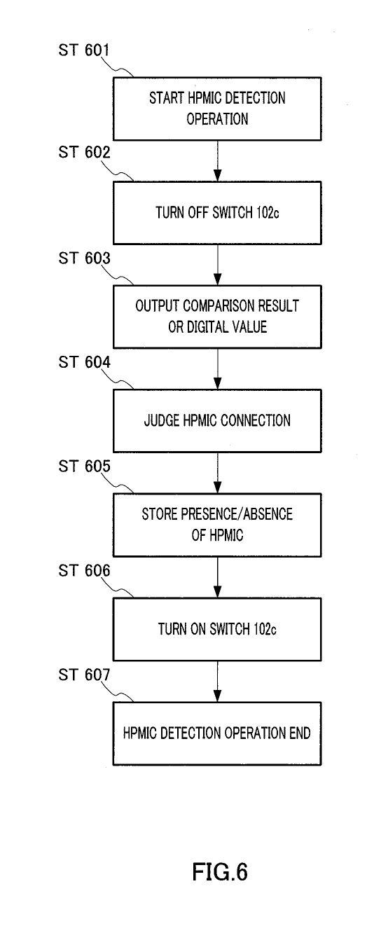

First, operations of electronic device 100 when detecting the presence/absence of headset microphone 161 after an application is started will be explained using FIG. 5 and FIG. 6.

According to FIG. 5, electronic device 100 starts an application (step ST 501). In this case, switch selection section 108 has selected main unit microphone 107 and variable amplifier 110 has set a predetermined gain g1. Here, starting the application means, for example, starting communication.

Next, headset 160 is connected to headset connection section 150 and control section 106 thereby electrically detects the presence of the connection of headset 160 via headset connection section 104 (step ST 502).

Next, voltage detecting section 105 starts an operation of detecting the presence/absence of headset microphone 161 (described as “HPMIC” in FIG. 5) of connected headset 160 (HPMIC connection detection operation start)(step ST 503). Details of the operation in step ST 503 will be described later.

Next, control section 106 detects the presence/absence of headset microphone 161 based on the signal level inputted from voltage detecting section 105 or the digital value of the supply voltage inputted from voltage detecting section 105 (step ST 504).

Upon detecting the presence of the headset microphone, electronic device 100 informs that headset microphone 161 has been selected (step ST 505). To be more specific, display section 117 displays character information indicating “headset microphone has been selected.” Furthermore, main unit speaker 116 or headset speaker 162 outputs voice information indicating “headset microphone has been selected” via voice.

Next, microphone selection section 108 selects headset microphone 161 (step ST 506).

Next, variable amplifier 110 amplifies analog voice data at gain g3 that matches the characteristic of headset microphone 161 (step ST 507).

Next, electronic device 100 starts a transmission operation (step ST 508).

On the other hand, when the absence of the headset microphone is detected in step ST 504, electronic device 100 informs that main unit microphone 107 has been selected (step ST 509). To be more specific, display section 117 displays character information indicating “main unit microphone has been selected.” Furthermore, main unit speaker 116 outputs voice information indicating “main unit microphone has been selected” via voice.

Next, microphone selection section 108 maintains the state in which main unit microphone 107 has been selected (step ST 510).

Next, variable amplifier 110 amplifies the analog voice data at gain g2 which is a value greater than gain g1 (g1<g2) (step ST 511).

Next, electronic device 100 starts a transmission operation (step ST 508).

Next, the HPMIC connection detection operation in step ST 503 will be explained using FIG. 6. FIG. 6 is a flowchart illustrating the HPMIC connection detection operation.

Electronic device 100 starts a detection operation on headset microphone 161 (described as “HPMIC” in FIG. 6) (step ST 601) and impedance setting section 102 turns off switch 102c (step ST 602).

Next, voltage detecting section 105 outputs a result of a comparison between the supply voltage and a threshold or a digital value of the supply voltage to control section 106 (step ST 603).

Next, control section 106 detects the presence/absence of headset microphone 161 based on the comparison result or the digital value of the supply voltage (HPMIC connection judgment) (step ST 604).

Next, data storage section 118 stores information about the presence/absence of headset microphone 161 (step ST 605).

Next, impedance setting section 102 turns on switch 102c (step ST 606).

Electronic device 100 then finishes the detection operation on headset microphone 161 (step ST 607) and then performs processing in and after step ST 504.

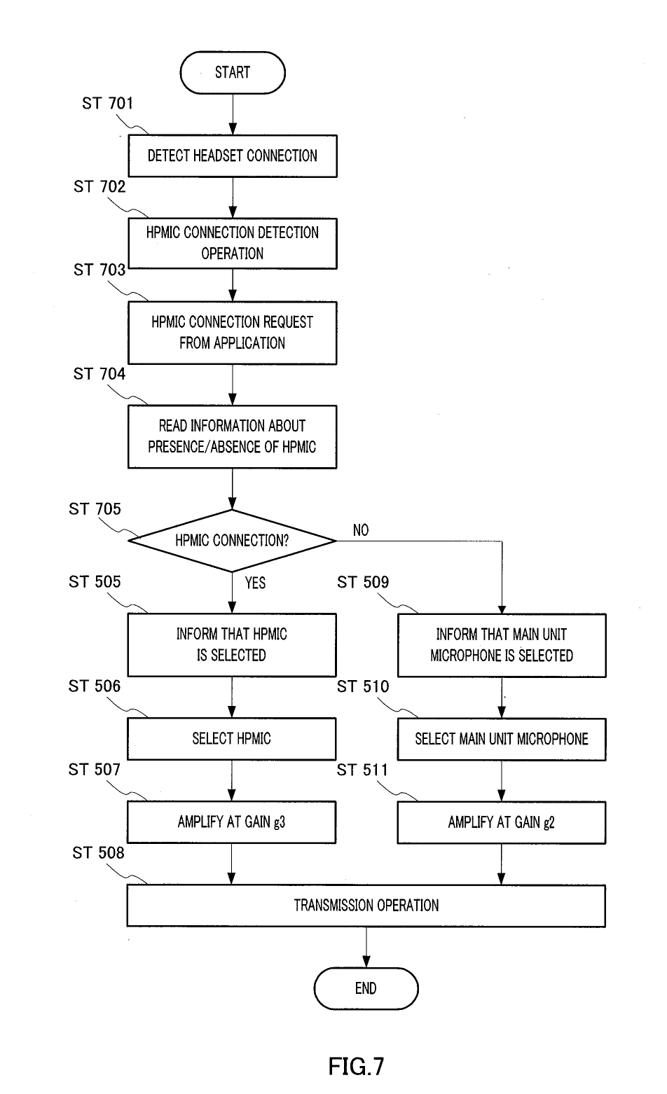

Next, operations of electronic device 100 when the presence/absence of headset microphone 161 is detected after headset 160 is connected to electronic device 100 will be explained using FIG. 7. In FIG. 7, parts having the same operations as those in FIG. 5 will be assigned the same reference numerals and explanations thereof will be omitted.

According to FIG. 7, when headset 160 is connected to headset connection section 150, control section 106 detects the connection of headset 160 via headset connection section 104 (step ST 701).

Next, voltage detecting section 105 starts a detection operation on the presence/absence of headset microphone 161 of connected headset 160 (described as “HPMIC” in FIG. 7) (HPMIC connection detection operation start) (step ST 702). Since the operation in step ST 702 is the same as that in FIG. 6, explanations thereof will be omitted.

Next, when an application is started and a connection of headset microphone 160 is thereby requested from the application (step ST 703), control section 106 reads information about the presence/absence of headset microphone 161 from data storage section 118 (step ST 704).

Next, control section 106 detects the presence/absence of headset microphone 161 from the read information about the presence/absence of headset microphone 161 (step ST 705).

Upon detecting the presence of the headset microphone, electronic device 100 informs that headset microphone 161 has been selected (step ST 505). To be more specific, display section 117 displays character information indicating “headset microphone has been selected.” Furthermore, main unit speaker 116 or headset speaker 162 outputs voice information indicating “headset microphone has been selected” via voice.

On the other hand, upon detecting the absence of the headset microphone, electronic device 100 informs that main unit microphone 107 has been selected (step ST 509). To be more specific, display section 117 displays character information indicating “main unit microphone has been selected.” Furthermore, main unit speaker 116 or headset speaker 162 outputs voice information indicating “main unit microphone has been selected” via voice.

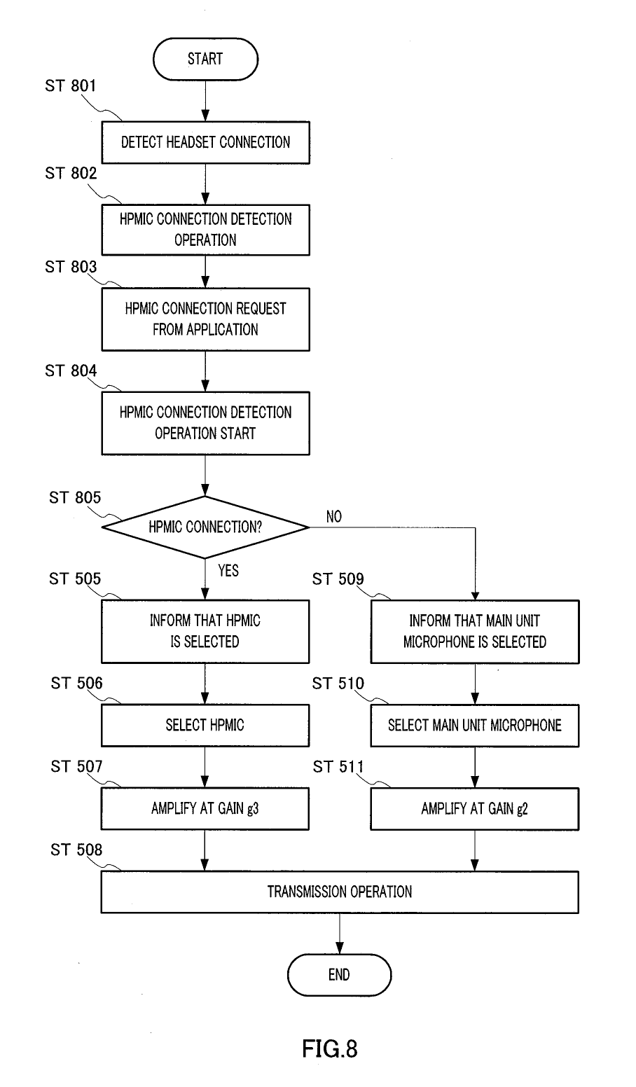

Next, another operation of electronic device 100 when the presence/absence of headset microphone 161 is detected after headset 160 is connected to electronic device 100 will be explained using FIG. 8. In FIG. 8, the same operations as those in FIG. 5 will be assigned the same reference numerals and explanations thereof will be omitted.

According to FIG. 8, since headset 160 is connected to headset connection section 150, control section 106 detects the connection of headset 160 via headset connection section 104 (step ST 801).

Next, voltage detecting section 105 starts a detection operation on the presence/absence of headset microphone 161 of connected headset 160 (described as “HPMIC” in FIG. 8) (HPMIC connection detection operation start) (step ST 802). Since the operation in step ST 802 is the same as that in FIG. 6, explanations thereof will be omitted.

Next, when an application is started in control section 106 and a connection of headset microphone 160 is thereby requested from the application (step ST 803), voltage detecting section 105 starts a detection operation on the presence/absence of headset microphone 161 of connected headset 160 (HPMIC connection detection operation start) (step ST 804). Since the operation in step ST 804 is the same as that in FIG. 6, explanations thereof will be omitted.

Next, control section 106 detects the presence/absence of headset microphone 161 based on a signal level inputted from voltage detecting section 105 or a digital value of the supply voltage inputted from detecting section 105 (step ST 805).

Upon detecting the presence of the headset microphone, electronic device 100 informs that headset microphone 161 has been selected (step ST 505). To be more specific, display section 117 displays character information indicating “headset microphone has been selected.” Furthermore, main unit speaker 116 or headset speaker 162 outputs voice information indicating “headset microphone has been selected” via voice.

On the other hand, upon detecting the absence of the headset microphone, electronic device 100 informs that main unit microphone 107 has been selected (step ST 509). To be more specific, display section 117 displays character information indicating “main unit microphone has been selected.” Furthermore, main unit speaker 116 or headset speaker 162 outputs voice information indicating “main unit microphone has been selected” via voice.

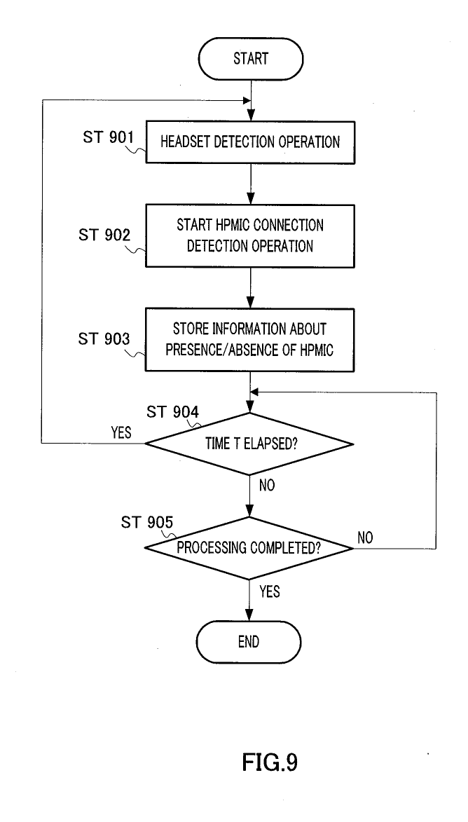

Next, operations of electronic device 100 when periodically detecting the presence/absence of headset microphone 161 after headset 160 is connected to electronic device 100 will be explained using FIG. 9.

According to FIG. 9, when headset 160 is connected to headset connection section 150, control section 106 thereby detects the connection of headset 160 via headset connection section 104 (step ST 901).

Next, voltage detecting section 105 starts the detection operation on the presence/absence of headset microphone 161 of connected headset 160 (described as “HPMIC” in FIG. 9) (HPMIC connection detection operation start) (step ST 902). Since the operation in step ST 902 is the same as that in FIG. 6, explanations thereof will be omitted.

Next, data storage section 118 stores information about the presence/absence of headset microphone 161 (step ST 903).

Next, control section 106 judges whether or not a T time, which is a predetermined period, to detect headset microphone 161 has elapsed (step ST 904).

When the T time has elapsed, the processing in step ST 901 to step ST 903 is repeated.

On the other hand, when the T time has not elapsed, control section 106 judges whether or not to finish the processing of detecting headset microphone 161 (step ST 905).

When the processing is not finished, the processing in step ST 904 is repeated.

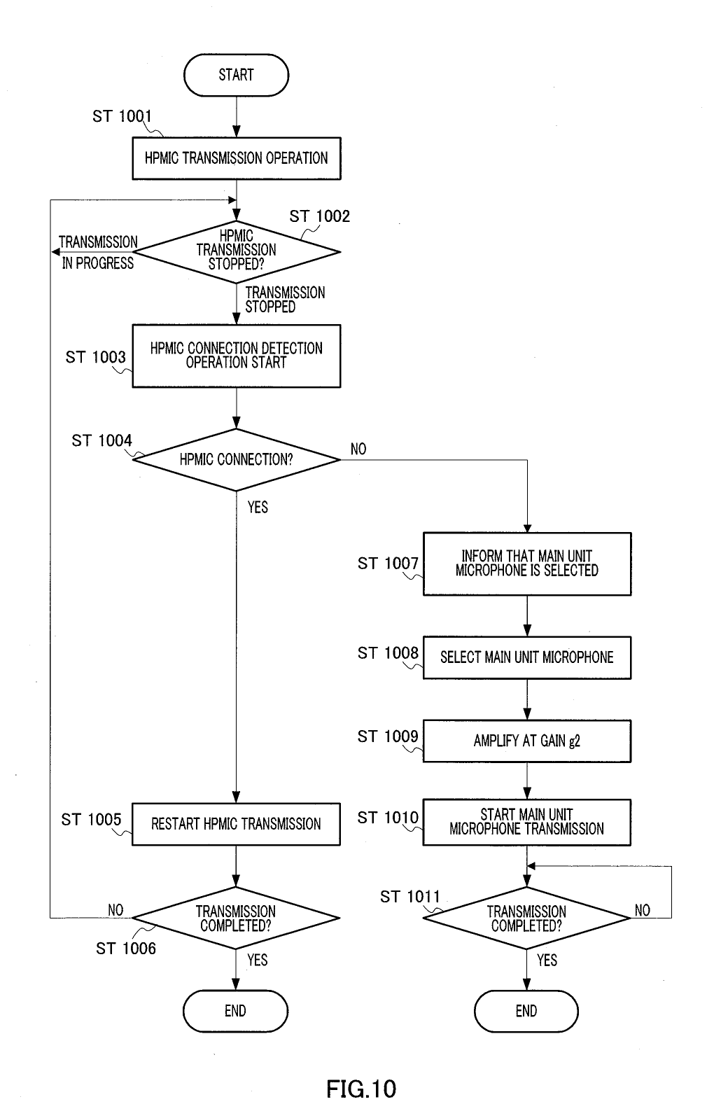

Next, the operation of electronic device 100 when the presence/absence of headset microphone 161 is detected after headset 160 is connected to electronic device 100 will be explained using FIG. 10.

According to FIG. 10, electronic device 100 performs a transmission operation using headset microphone 161 (described as “HPMIC” in FIG. 10) (step ST 1001). In this case, switch selection section 108 has selected headset microphone 161 and variable amplifier 110 has set gain g3.

Next, control section 106 judges whether or not the transmission by headset microphone 161 has stopped (step ST 1002). Here, the state in which the transmission by headset microphone 161 is stopped is a state in which control section 106 is not capturing voice data.

When the transmission is in progress, control section 106 repeats the processing in step ST 1002. On the other hand, when the transmission is stopped, voltage detecting section 105 starts a detection operation on the presence/absence of headset microphone 161 of connected headset 160 (HPMIC connection detection operation start) (step ST 1003). The operation in step ST 1003 is the same as that in FIG. 6, and so explanations thereof will be omitted.

Next, control section 106 detects the presence/absence of headset microphone 161 based on a signal level inputted from voltage detecting section 105 or a digital value of the supply voltage inputted from voltage detecting section 105 (step ST 1004).

When the presence of the headset microphone is detected, electronic device 100 restarts the transmission of headset microphone 161 (step ST 1005).

Next, electronic device 100 judges whether or not to finish the transmission (step ST 1006). When the transmission is not finished, the processing in step ST 1002 to step ST 1005 is repeated.

On the other hand, when the absence of the headset microphone is detected in step ST 1004, electronic device 100 informs that main unit microphone 107 has been selected (step ST 1007). To be more specific, display section 117 displays character information indicating “main unit microphone has been selected.” Furthermore, main unit speaker 116 or headset speaker 162 outputs voice information indicating “main unit microphone has been selected” via voice.

Next, microphone selection section 108 selects main unit microphone 107 (step ST 1008).

Next, variable amplifier 110 amplifies the analog voice data at gain g2(g2>g1) (step ST 1009).

Next, electronic device 100 starts transmission using main unit microphone 107 (step ST 1010).

Next, electronic device 100 judges whether or not to finish the transmission (step ST 1011). When the transmission is not finished, the processing in step ST 1011 is repeated.

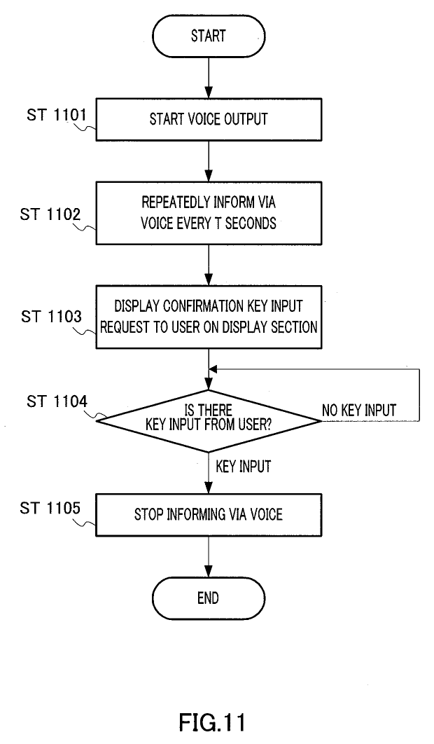

Next, the method of informing via voice that headset microphone 161 or main unit microphone 107 has been selected will be explained using FIG. 11. FIG. 11 is a flowchart illustrating the method of informing via voice that headset microphone 161 or main unit microphone 107 has been selected.

First, main unit speaker 116 or headset speaker 162 starts voice output (step ST 1101).

Next, main unit speaker 116 or headset speaker 162 repeatedly informs via voice that headset microphone 161 or main unit microphone 107 has been selected for T seconds (step ST 1102).

Next, display section 117 displays a message to prompt the user to input a confirmation key indicating that headset microphone 161 or main unit microphone 107 has been selected (step ST 1103).

Next, control section 106 judges whether or not a confirmation key has been inputted (step ST 1104).

When a confirmation key has been inputted, main unit speaker 116 or headset speaker 162 stops informing via voice that headset microphone 161 or main unit microphone 107 has been selected (step ST 1105).

On the other hand, when a confirmation key has not been inputted, control section 106 repeats the processing in step ST 1104.

Furthermore, upon detecting that the connection between electronic device 100 and headset 160 has been canceled during the processing in step ST 1102 to step ST 1105, control section 106 stops informing via voice in step ST 1102.

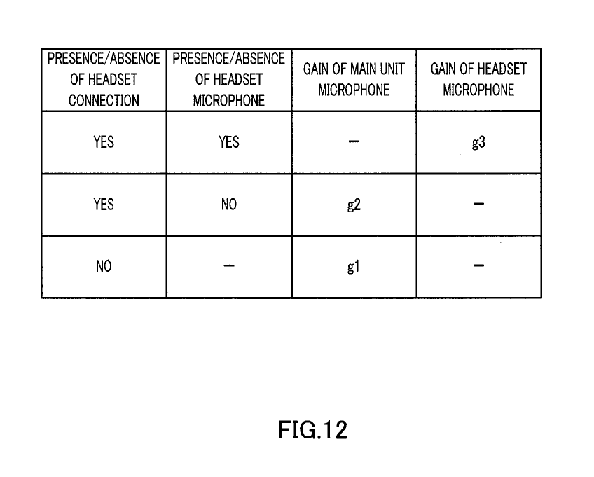

FIG. 12 illustrates the gain to be set in gain setting section 109.

According to FIG. 12, when control section 106 detects the presence of the connection of the headset and the presence of the headset microphone, gain setting section 109 sets predetermined gain g3. Thus, variable amplifier 110 amplifies the signal of headset microphone 161 at gain g3. Since the signal of main unit microphone 107 is not inputted to variable amplifier 110, gain setting section 109 never sets the gain to amplify the signal of main unit microphone 107.

Furthermore, when control section 106 detects the presence of the connection of the headset and the absence of the headset microphone, gain setting section 109 sets gain g2. Thus, variable amplifier 110 amplifies the signal of main unit microphone 107 at gain g2. In this case, gain setting section 109 never sets the gain to amplify the signal of headset microphone 161.

Furthermore, when control section 106 detects the absence of the connection of the headset, gain setting section 109 sets gain g1. Thus, variable amplifier 110 amplifies the signal of main unit microphone 107 at gain g1. In this case, gain setting section 109 never sets the gain to amplify the signal of headset microphone 161.

Here, while a condition of g1<g2 holds between g1 and g2, there is no particular condition that holds between g1 and g3 and between g1 and g3 and any conditions can be set. g3 is a gain for the headset microphone and may be set in accordance with the characteristic of the headset microphone.

Thus, the present embodiment automatically adjusts the gain according to the presence/absence of the headset microphone, and can thereby improve the sound collecting performance and prevent sound from being carelessly collected by the microphone. Furthermore, the present embodiment informs, via voice and display, that the main unit microphone has been selected or headset microphone has been selected, and therefore when the user cannot visually recognize the display section or when voice cannot be heard, the user can reliably recognize the type of the selected microphone. Furthermore, the present embodiment supplies power with an increased impedance when detecting the headset microphone compared to when not detecting the headset microphone, and can thereby increase the amount of drop in the supply voltage due to the connection of the headset microphone and reliably detect the headset microphone.

By the way, in an electronic device formed with an electronic circuit such as a portable communication terminal or a mobile phone having a conversation function, when using a headset provided with a headset microphone, the user need not care the position of the main unit microphone of the electronic device because the headset microphone is located near his/her mouth and as a consequence, the user normally places the main unit microphone apart from the mouth. However, when the user attaches a headset provided without a headset microphone to the electronic device by mistaking it for a headset provided with a headset microphone and the main unit microphone collects the voice of the user, the voice of the user collected is subdued because the main unit microphone is placed apart from the user's mouth.

It is an object of the present embodiment to solve such a problem and when a headset provided without a headset microphone is attached, the present embodiment adopts a greater gain (g2) of the main unit microphone than a normal gain (g1) when no headset is attached and sufficiently amplifies voice uttered from the user's mouth apart from the main unit microphone. Thus, it is possible to avoid such a situation that while being engaged in conversation with a communicating party on a mobile phone, immediately after the user wears a headset provided without a headset microphone, the user's voice heard by a communicating party is suddenly excessively subdued and it suddenly becomes impossible to hold the conversation.

### INDUSTRIAL APPLICABILITY

The electronic circuit, electronic device and gain control method according to the present invention is particularly suitable for automatically detecting the presence/absence of the headset microphone of a headset and adjusting the gain.

1. An electronic circuit comprising:
a detecting section that detects the presence and absence of a connection of a headset and the presence and absence of a headset microphone of the connected headset;
a gain setting section that sets a first gain when the detecting section detects the absence of the connection of the headset and sets a second gain greater than the first gain when the detecting section detects the presence of the connection of the headset and detects the absence of the headset microphone; and
an amplification section that amplifies a signal inputted from the main unit microphone at the first gain or the second gain.

2. The electronic circuit according to claim 1, further comprising a microphone selection section that selects the main unit microphone when the detecting section detects the presence of the connection of the headset and the absence of the headset microphone or the absence of the headset microphone, or selects the headset microphone when the detecting section detects the presence of the headset microphone.

3. The electronic circuit according to claim 2, further comprising an informing section that informs via voice from a speaker to the outside that the main unit microphone has been selected when the detecting section detects the presence of the connection of the headset and the absence of the headset microphone.

4. The electronic circuit according to claim 3, wherein when the detecting section detects the absence of the connection of the headset, the informing section does not inform via voice from the speaker to the outside that the main unit microphone has been selected.

5. The electronic circuit according to claim 3, wherein, when the detecting section detects the presence of the connection of the headset and the presence of the headset microphone, the informing section informs via voice from the speaker to the outside that the headset microphone has been selected.

6. The electronic circuit according to claim 1, further comprising an output section that outputs a signal amplified by the amplification section to a headset speaker of the headset.

7. The electronic circuit according to claim 1, further comprising an outside communication section that sends the signal amplified by the amplification section to an outside device.

8. The electronic circuit according to claim 1, wherein the detecting section periodically detects the presence and absence of the headset microphone.

9. The electronic circuit according to claim 1, wherein the detecting section detects the presence and absence of the headset microphone when a communication start is detected.

10. The electronic circuit according to claim 1, further comprising a power supply section that sets a higher impedance when the presence and absence of the headset microphone is detected than when the presence and absence of the headset microphone is not detected and supplies power to the headset microphone, wherein:
the detecting section detects the presence of the headset microphone when an amount of voltage drop of the power supplied from the power supply section is equal to or above a predetermined value.

11. An electronic device comprising the electronic circuit according to claim 1, the electronic circuit comprising:
a detecting section that detects the presence and absence of a connection of a headset and the presence and absence of a headset microphone of the connected headset;
a gain setting section that sets a first gain when the detecting section detects the absence of the connection of the headset and sets a second gain greater than the first gain when the detecting section detects the presence of the connection of the headset and detects the absence of the headset microphone; and
an amplification section that amplifies a signal inputted from the main unit microphone at the first gain or the second gain.

12. A gain control comprising the steps of:
detecting the presence and absence of a connection of a headset and the presence and absence of a headset microphone of the connected headset; and
setting a first gain when the absence of the connection of the headset is detected and setting a second gain greater than the first gain when the presence of the connection of the headset and the absence of the headset microphone are detected.

13. A gain control circuit that executes the gain control method according to claim 12.
